(19) United States
(12) Patent Application Publication
(10) Pub. No.: US 2009/0112900 A1
(43) Pub. Date: Apr. 30, 2009

(54) Collaborative Compression

(76) Inventors: Krishnamurthy Viswanathan, Sunnyvale, CA (US); Ram Swaminathan, Cupertino, CA (US); Mustafa Uysal, Vacaville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/930,982

(22) Filed: Oct. 31, 2007

(51) Int. Cl. G06F 17/30

(52) U.S. Cl. 707/101; 707/E17.044

(57) ABSTRACT

Provided are, among other things, systems, methods and techniques for collaborative compression, in which is obtained a collection of files, with individual ones of the files including a set of ordered data elements (e.g., bit positions), and with individual ones of the data elements having different values in different ones of the files, but with the set of ordered data elements being common across the files. The data elements are partitioned into an identified set of bins based on statistics for the values of the data elements across the collection of files, and a received file is compressed based on the bins of data elements.

### FIELD OF THE INVENTION

The present invention pertains to systems, methods and techniques for compressing files and is applicable, e.g., to the problem of compressing multiple similar files.

### BACKGROUND

Consider the problem of losslessly compressing a collection of files that are similar. This problem commonly arises due to vast amounts of data gathered in document archives, image libraries, disk-based backup appliances, and photo collections. Most conventional compression techniques treat each file as a separate entity and take advantage of the redundancy within a file to reduce the space required to store the file. However, this approach leaves the redundancy across files untapped.

The problem of compressing one file with respect to another by encoding the modifications that convert one to the other has received a fair amount of attention in data compression literature. This problem is also called differential compression. However, using or extending this technique to compress a large collection of files is not believed to have been proposed in the prior art, and such an extension is non-trivial. Probably because of these difficulties, the conventional techniques for compressing multiple similar files have taken other approaches.

For example, one such approach is based on string matching. Most of the solutions that fall in this category (e.g., M. Factor and D. Sheinwald, “Compression in the presence of shared data”, Information Sciences, 135:29-41, 2001) can be viewed as a variant of a scheme that concatenates all the files to be compressed into a giant string and compresses the string using LZ 77 compression. The amount of compression obtained with such techniques typically is poor if the buffer size is fixed; on the other hand, the technique generally becomes computationally complex and runs into problems related to memory-overflow if the buffer size is not fixed.

A further approach, commonly referred to as “chunking”, parses files into variable-length phrases and compresses by storing a single instance of each phrase along with a hash (codeword) used to look up the phrase (e.g., K. Eshghi. M. Lillibridge, L. Wilcock, G. Belrose, and R. Hawkes, “Jumbo Store: Providing efficient incremental upload and versioning for a utility rendering service”, Proceedings of the 5nd USENIX Conference on File and Storage Technologies (FAST'07), pp. 123-138, San Jose, Calif., February 2007). This approach typically is faster than string matching. However, frequent disk access may be required if new chunks are observed frequently. Moreover, even for simple models of file similarity, the compression ratio achieved by such approaches is likely to be suboptimal.

### SUMMARY OF THE INVENTION

The present invention addresses this problem by, among other approaches, partitioning common data elements across files into an identified set of bins based on statistics for the values of the data elements across the collection of files and compressing a received file based on the identified bins of data elements.

Thus, in one aspect the invention is directed to collaborative compression, in which is obtained a collection of files, with individual ones of the files including a set of ordered data elements (e.g., bit positions), and with individual ones of the data elements having different values in different ones of the files, but with the set of ordered data elements being common across the files. The data elements are partitioned into an identified set of bins based on statistics for the values of the data elements across the collection of files, and a received file is compressed based on the bins of data elements.

By virtue of the foregoing arrangement, it often is possible to efficiently compress an entire collection of similar files. In certain representative embodiments, the bins are used to construct a source file estimate, which is then used to differentially compress the individual files. Other embodiments generate streams of data values based on the bin partitioning and then separately compress those streams, without the intermediary of a source file estimate.

In another aspect, the invention is directed to collaborative compression, in which a collection of files is obtained, with individual ones of the files including a set of ordered data elements, and with individual ones of the data elements having different values in different ones of the files, but with the set of ordered data elements being common across the files. A source file estimate is constructed based on statistics for the values of the data elements across the collection of files, and a received file is compressed relative to the source file estimate.

The foregoing summary is intended merely to provide a brief description of certain aspects of the invention. A more complete understanding of the invention can be obtained by referring to the claims and the following detailed description of the preferred embodiments in connection with the accompanying figures.

### BRIEF DESCRIPTION OF THE DRAWINGS

In the following disclosure, the invention is described with reference to the attached drawings. However, it should be understood that the drawings merely depict certain representative and/or exemplary embodiments and features of the present invention and are not intended to limit the scope of the invention in any manner. The following is a brief description of each of the attached drawings.

FIG. 1 is a block diagram illustrating the concept of multiple similar files having been derived from a single source file.

FIG. 2 is a flow diagram illustrating a general approach to file compression according to certain preferred embodiments of the invention.

FIG. 3 illustrates a collection of files that include a common set of data elements.

FIG. 4 is a flow diagram illustrating an overview of a compression method that uses a source file estimate.

FIG. 5 is a block diagram illustrating a system for compressing and decompressing files based on a source file estimate.

FIG. 6 is a flow diagram illustrating a method for constructing a source file estimate.

FIG. 7 illustrates a De Bruijn graph for sequences of two-bit string contexts.

FIG. 8 is a flow diagram illustrating a first approach to compressing a file without constructing a source file estimate.

FIG. 9 illustrates the partitioning of an original file into data streams for separate compression.

FIG. 10 is a flow diagram illustrating a second approach to compressing a file without constructing a source file estimate.

### DESCRIPTION OF THE PREFERRED EMBODIMENT(S)

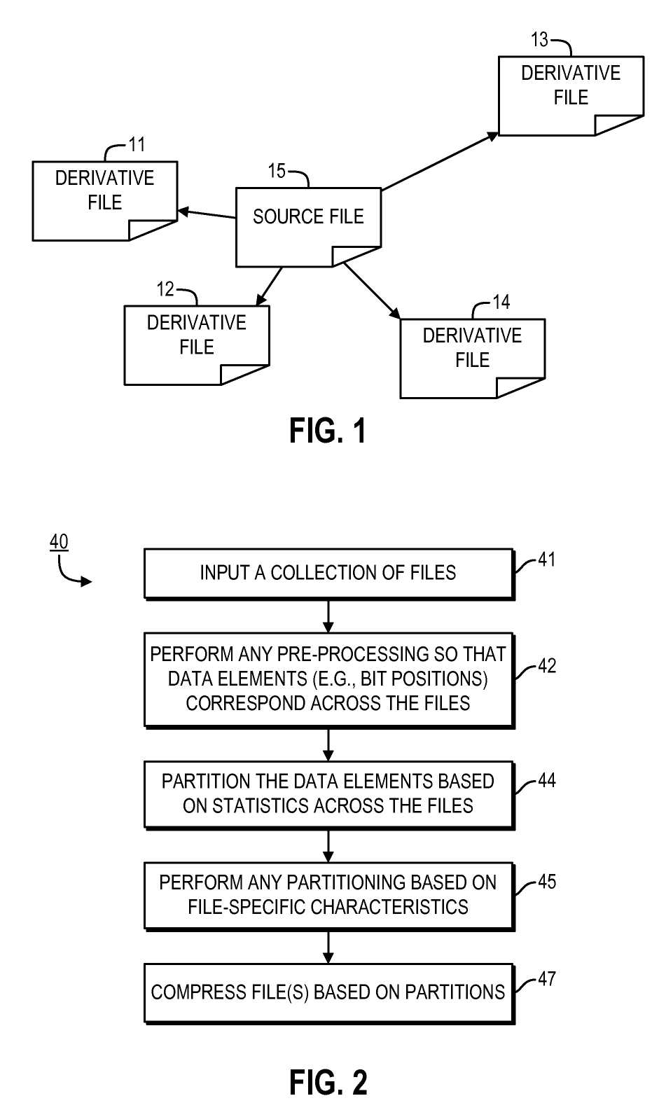

The present invention concerns, among other things, techniques for facilitating the compression of multiple similar files. In many cases, as shown in FIG. 1, the files 11-14 that are sought to be compressed can be thought of as having been generated as modifications or derivations of some underlying source file 15. That is, beginning with a source file 15, each of the individual files 11-14 can be constructed by making appropriate modifications to the source file 15, with such modifications generally being both qualitatively and quantitatively different for the various files 11-14.

In fact, such a conceptualization often is possible even where some or all of the files 11-14 have not been derived from a common source file 15, provided that the files 11-14 are sufficiently similar to each other. For example, such similarity might arise because the files 11-14 have been generated in a similar manner, e.g., where multiple different photographs, each represented as a bitmap image, have been taken of the Eiffel Tower from roughly the same vantage point but using different cameras and/or camera settings, and/or under somewhat different lighting conditions.

As discussed in more detail below, certain embodiments of the invention explicitly attempt to construct a source file estimate and then compress one or more files relative to that source file. Other embodiments do not rely upon such a construct. In any event, the preferred embodiments of the invention compress files by partitioning common data elements (such as bit positions) across a collection of files and using those partitions, either directly or indirectly, to organize and/or process file data in a manner so as to facilitate compression.

FIG. 2 is a flow diagram illustrating a process 40 for compressing files according to certain preferred embodiments of the invention. Each of the steps in process 40 preferably is performed in a predetermined manner, so that the entire process 40 can be performed by a computer processor executing machine-readable process steps, or in any of the other ways described herein.

Initially, in step 41 a collection of files (e.g., including m different files) is input. Preferably, such files are known to be similar to each other, either by the way in which they were collected (e.g., different versions of a document in progress) or because they have been screened for similarity from a larger collection of files.

In step 42, any desired pre-processing is performed, with the preferred goal being to ensure that the set of data elements in each file corresponds to the set of data elements in each of the other files. It is noted that in some cases, no such pre-processing will be performed (e.g., where all of the files are highly structured, having a common set of fields arranged in exactly the same order). In one such specific example, the obtained files are the Microsoft Windows™ registries for all of the personal computers (PCs) on an organization's computer network. Here, it can be expected that not only will the fields be identical, but the data values within those fields generally will have significant similarities, particularly where the organization has mandated common settings across all, or a large number of, its computers.

In other cases, some amount of pre-processing will be desirable. For example, in probably the most general case, the data elements are simply the bit positions within the files (e.g., arranged sequentially and numbered from 1 to n). In this case, any files that are shorter than n bits long can be padded with zeros so that all files in the set are of equal length (i.e., n bits long). In certain embodiments, such padding is applied uniformly to the beginning or to the end of each file that initially is shorter than n bits. However, in other embodiments, such padding is applied in the middle of files, e.g., where the files have natural segmentation (e.g., pages in a PDF or PowerPoint document file) or where they are segmented as part of the pre-processing (e.g., based on identified similarity markers); in these cases, padding can be applied, e.g., as and where appropriate to equalize the lengths of the individual segments.

To the extent any pre-processing has been performed on a file, the details of such processing preferably are stored in association with the file for subsequent reversal upon decompression.

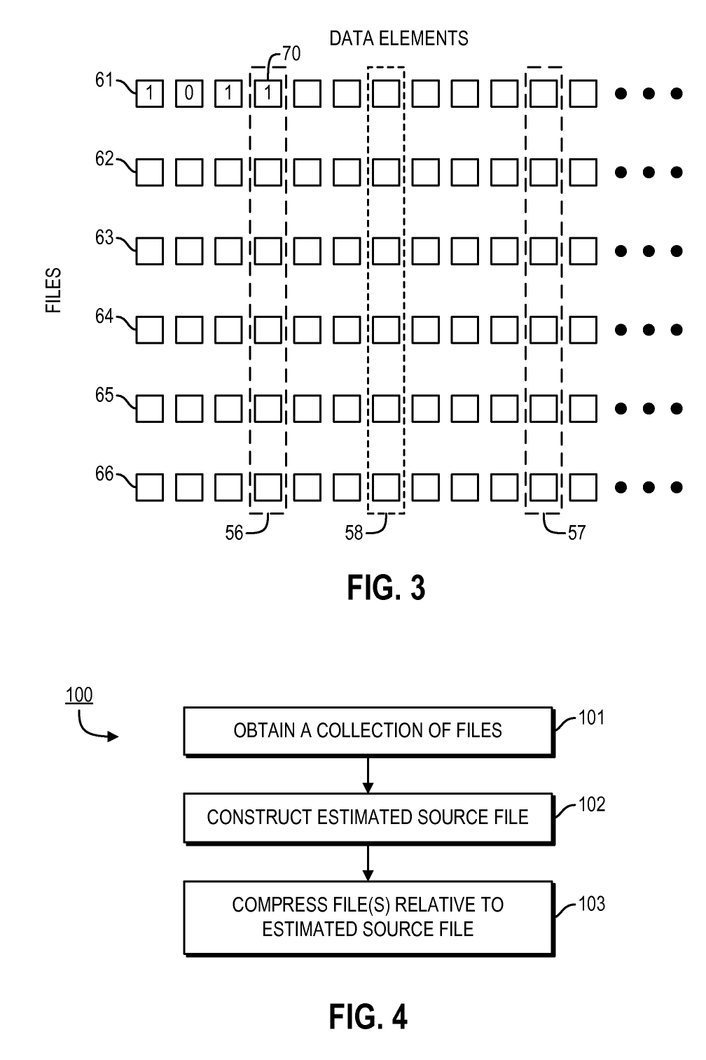

In any event, the resulting collection of files preferably can be visualized as shown in FIG. 3, with each row corresponding to a different file (e.g., files 61-66) and each column corresponding to a different data element (e.g., data elements 56-58). That is, each file preferably has the same set of data elements, arranged in exactly the same order, although the values for those data elements typically will differ somewhat across the files. More preferably, no file has any data element that does not exist (in the same position) in each of the other files, so that each value within the collection of files can be uniquely designated using a file designation and a data-element designation.

Although only a handful of files and data elements are shown in FIG. 3, this is for ease of illustration only; in practice, there often will be tens, hundreds or even more files and hundreds, thousands, tens of thousands or even more data elements. Also, although shown as a one-dimensional sequence of data elements, depending upon the kinds of files, each file instead might be better represented as a two-dimensional or even a higher-dimensional array of data elements. Each data element is referred to herein as having a “value” which, e.g., depending upon the nature of the data element, might be a binary value (where the data elements correspond to different bit positions), an integer, a real number, a vector of sub-values, or any other kind of value.

Returning to FIG. 2, in step 44 the data elements are partitioned into bins based on statistics of the data element values across the collection of files. For example, in one embodiment in which each data element corresponds to a single bit position, each such bit position is assigned to a bin based on the fraction of files having a specified value (e.g., the value “1”) at that bit position. More specifically, assuming that there are eight bins, in this example a bit position is assigned to the first bin if the fraction of files having the value “1” at that bit position is less than 0.125, is assigned to the second bin if the fraction is greater than or equal to 0.125 but less than 0.25, is assigned to the third bin if the fraction is greater than or equal to 0.25 but less than 0.375, and so on. It is noted that in this embodiment, a single statistical metric (e.g., a representative value, such as the mean or median) across the files (e.g., across all of the files) is used in assigning a data element to a bin, and that single statistical metric is based solely on the value of that data element itself across the files (without reference to the values of any other data elements).

In alternate embodiments, the bin assignments are context-sensitive, e.g., with the assignment of a particular data element being based on the values for nearby data elements as well as the values of the particular data element itself. For example, in one particular such embodiment the set of bit-positions {1, 2, . . . , n} is partitioned into bins as follows. For each bit position 1≦j≦n, and for each k-bit string cε{0,1}^{k}, a determination is made of nⱼ(c), the fraction of files in which “1” appears in bit position j when its context, in this embodiment the k previous bits, equals c. The set {1, 2, . . . , n} of bit positions is then partitioned into at most l bins, B₁, B₂, . . . , Bₗ, such that for all 1≦j₁≠j₂≦n, j₁ and j₂ fall in the same bin only if, for all cε{0,1}^{k}, |nⱼ_{₁}(c)−nⱼ_{₂}(c|≦T,

where l is an input integer establishing a maximum number of bins (e.g., between 2-32)
and T preferably is set equal to

$$\frac{A log n}{\sqrt{n}} ,$$

with A being an input real number roughly corresponding to maximum cluster width (e.g., in the approximate range of 2-3). In this regard, it is noted that the present approach can be understood as a form of context-sensitive clustering of data elements. In the present embodiment, all of the fractions nⱼ(c) for any two bit positions, across all contexts c, must lie within a specified maximum distance. If not, in certain implementations of the present embodiment, one or more of the parameters are adjusted (e.g., by reducing k) until this condition is satisfied. Also, it is noted that in alternate embodiments, other context-sensitive clustering criteria are used, such as by assigning less weight to contexts that are less statistically significant.

The foregoing embodiments utilize a single statistical metric in assigning data elements (which occur across the files) to particular bins. However, in other embodiments a combination of such metrics and/or any other desired metrics is used in making such assignments.

In any event, upon completion of this step 44 the data elements have been partitioned into bins. Thus, for example, referring to FIG. 3, data elements 56 and 57 (each having a value in each of the files 61-66) are assigned to one bin and data element 58 (also having a value in each of the files 61-66) is assigned to a different bin. In the preferred embodiments, each data element is assigned to one of the bins, preferably based on some clustering criterion. It is noted that, although certain partitions are referred to as “bins” herein, this designation is not intended to be limiting; in fact, as described in more detail below, particularly where individual data values are involved, the partitions sometimes are better visualized as “streams”.

Returning again to FIG. 2, in step 45 any desired partitioning based on file-specific characteristics is performed. Thus, for example, the values corresponding to the data elements in the individual bins identified in step 44 might be further partitioned into sub-bins (or sub-streams) based on one or more file-specific criterion, such as context within the file. More specifically, in one particular embodiment the bit values within each bin are partitioned into eight sub-bins based on the values of the immediately three preceding bits. Accordingly, applying this embodiment to the example shown in FIG. 3, the bit value for each of the bits (61, 56), (62, 56), (63, 56), (64, 56), (65, 56), (66, 56), (61, 57), (62, 57), (63, 57), (64, 57), (65, 57), (66, 57), . . . , where (x,y) denotes the bit at bit position y in file x, is assigned to sub-bin 0 if the three preceding the values in the file are 000, assigned to sub-bin 1 if the three preceding the values in the file are 001, assigned to sub-bin 2 if the three preceding the values in the file are 010, and so on. Thus, bit 70, which would be designated as (61, 56) according to this nomenclature, is assigned to sub-bin 5 because the values for the three preceding bits 71-73 in its file are 101, respectively. At the same time, the values for data element 58 preferably would be divided into separate sub-streams because data element 58 belongs to a different bin than data elements 56 and 57.

Although step 45 is shown and discussed as occurring after step 44, it should be understood that this sequence may be reversed and/or may be performed in any desired sequence. For example, in one alternate embodiment data elements and/or values are first partitioned based on file-specific considerations or characteristics, then sub-partitioned based on statistics or other considerations across the files, and then further sub-partitioned based on other file-specific considerations or characteristics.

Finally, in step 47 one or more files are compressed based on the partitions that have been made. As described more fully below, the present invention generally contemplates two categories of embodiments. In the first, the identified partitions are used to construct a source file estimate (e.g., an estimate of source file 15 shown in FIG. 1) and then that source file estimate is used as a reference for differentially compressing such file(s). In the second category, the partitions (or sub-partitions) are treated as streams (or sub-streams) of data values and are separately compressed, without generating any kind of source file estimate.

Ordinarily, in the preferred embodiments of the invention, all of the files in the collection that initially was obtained in step 41 (e.g., all the files used for determining the partitions) are compressed in this manner. However, in some cases only a subset of such files are compressed, and/or in some cases additional files (e.g., files that were not used to determine the partitions) are compressed based on the partition information that was obtained in step 44 and/or in step 45. The latter case is particularly useful, e.g., where it is expected that a newly received file has similar statistical properties as the files that were used in step 44 and/or step 45.

Several more-specific embodiments of the invention are now described in more detail. The preferred implementations of the following embodiments generally track the method 40 described above. However, as explained in more detail below, the ways in which the various steps of method 40 are performed can vary across different implementations of the following embodiments. In other implementations/embodiments described below, the features discussed above in connection with method 40 are extended, modified and/or omitted, as appropriate.

A method 100 for compressing files using a source file estimate according to the preferred embodiments of the present invention is depicted in FIG. 4. Each of the steps illustrated in FIG. 4 preferably is performed in a predetermined manner, so that the entire process 100 can be performed by a computer processor executing machine-readable process steps, or in any of the other ways described herein.

Briefly, with reference to FIG. 4, in step 101 a collection of files is obtained, in step 102 a source file estimate is constructed based on those files, and then in step 103 one or more files are compressed based on the source file. The considerations pertaining to step 101 are the same as those pertaining to steps 41 and 42, discussed above. The considerations pertaining to compression step 103 are the same as those in step 47, discussed above, with the actual compression technique that is used (once the source file has been constructed) being any available (e.g., conventional) technique for differentially compressing one file relative to another (e.g., P. Subrahmanya and T. Berger, “A sliding-window Lempel-Ziv algorithm for differential layer encoding in progressive transmission”, Proceedings of IEEE Symposium on Information Theory, page 266, 1995). Most of the significant aspects of the present embodiments, beyond the considerations described above and elsewhere in this disclosure, pertain to the construction of a source file estimate in step 102; that step is described in detail below.

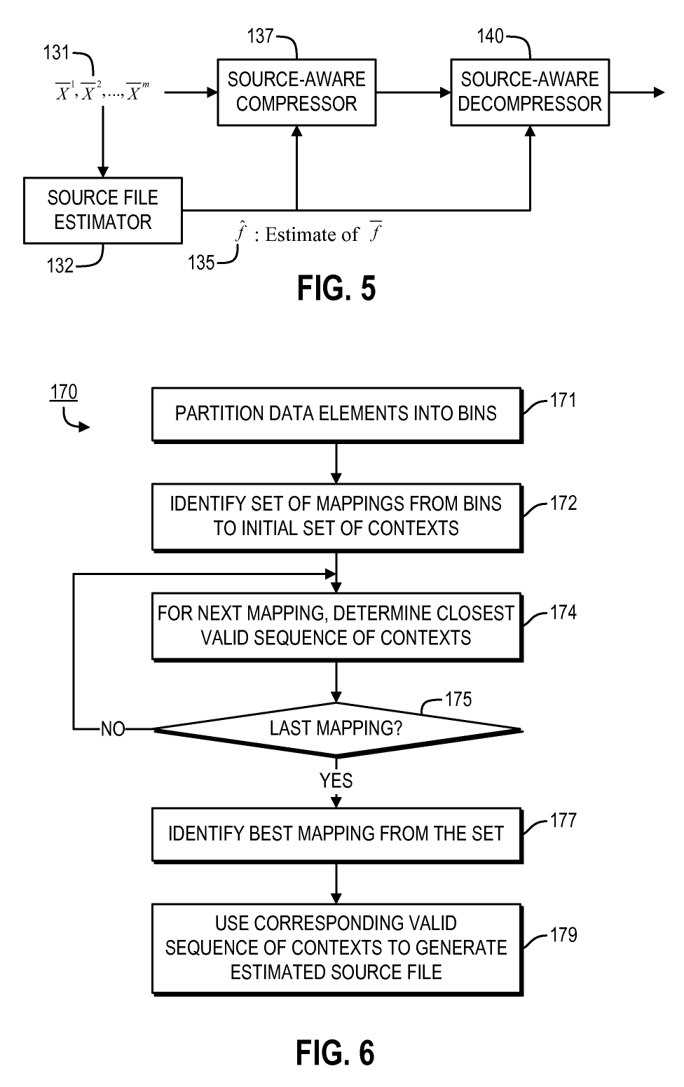

Initially, however, FIG. 5 illustrates the context in which the present embodiment preferably operates. The collection of files 131 that is obtained in step 101 initially is input into source file estimator 132 which preferably executes process 170 (described below) in order to generate an estimate \hat{f} 135 of an assumed underlying source file f̅. Source file estimate 135 can be conceptualized as a kind of centroid of the set of input files 131. In the preferred embodiments, source file estimate 135 is constructed in a manner that takes into account the kind of differential compression that ultimately will be performed in compression module 137. Both the files 131 and the source file estimate 135 are input into source-aware compressor 137, which preferably separately compresses each of the input files 131 (as well as any additional files, not shown, which preferably have been identified as having been generated in a similar manner to files 131) relative to the source file estimate 135, e.g., using any available technique for that purpose (e.g., any conventional technique for differentially compressing one file relative to another, preferably losslessly). Later, when any particular file is desired to be retrieved, its compressed version is input into source-aware decompressor 140, together with the source file estimate 135, which then performs the corresponding decompression. Such decompression preferably is a straightforward reversal of the compression technique used in module 137.

The files 131 preferably share a common set of data elements (either by their nature or as a result of any pre-processing performed in step 101). Accordingly, files 131 preferably can be visualized as files 61-66 in FIG. 3. More preferably, each of the data elements preferably is a different bit position, so each file is considered to be a sequence of ordered bit positions. The approach of the present embodiment is particularly applicable in such a context, i.e., with respect to a model in which there is a real or assumed source file 15 and the input files 131 (or 61-66) are assumed to have been generated by starting with the source file 15 and changing individual bit values (or values of other data elements), and particularly where such bit-flipping is context-dependant.

A representative method 170 for constructing the source file estimate 135 is now described with reference to FIG. 6. Each of the steps of method 170 preferably is performed in a predetermined manner, so that the entire process 170 can be performed by a computer processor executing machine-readable process steps, or in any of the other ways described herein.

Initially, in step 171 the data elements are partitioned into bins. In order to simplify the present discussion, it is assumed that each data element is a different bit position. However, it should be understood that this example is intended merely to make the presented concepts a little more concrete and, ordinarily, any reference herein to a “bit position” can be generalized to any other kind of data element.

The partitioning performed in step 171 can use any of the techniques described above in connection with steps 44 and 45 in FIG. 1. However, for the present embodiment, the partitioning preferably is performed solely or primarily based on statistics for the data element values across the collection of files 131. Thus, in one preferred implementation, the data elements are partitioned into 2^{k} bins based on the context-sensitive representative values across the collection of files 131, e.g., using any of the techniques described above in connection with steps 44. In the present example, in which the data elements are bit positions (each having a value of either 0 or 1), such a partitioning criterion can be equivalently stated as the context-sensitive fraction of files at which the bit position has the value 1 (or, equivalently 0). As indicated above, the data elements can be clustered into the 2^{k} different bins based on such context-sensitive fractions using any desired clustering technique.

In step 172, one or more mappings (preferably, one-to-one mappings) are identified between the 2^{k} bins and 2^{k} corresponding initial contexts (e.g., k-bit strings, in the present example) in the source file estimate 135 to be constructed. That is, the goal is to map each data element to a single context in the source file estimate 135, with all of the data elements in each bin being mapped to the same context in the source file estimate 135.

Each bit position fᵢ in the ultimate source file estimate has a context consisting of fᵢ itself, possibly some number of bits before fᵢ and possibly some number of bits after fᵢ. Although this “context window” can be different (in terms of sizes and/or positions relative to fᵢ) for different i, the present discussion assumes that all such context windows are identical. That is, it is assumed that each such context window includes the same number of bits l to the left of fᵢ and the same number of bits r to the right of fᵢ, so that the context of the i^{th} bit in the source file estimate 135 is fᵢ₋ₗ . . . fᵢ . . . fᵢ₊ᵣ, where r+l+1=k, the total number of bits required to describe the context.

Each mapping f: {1, 2, . . . 2^{k}}→{0,1}^{k}, from the set of bins to {0,1}^{k}, defines a sequence of contexts. To see this, assume that B: {l+1, l+2, . . . , n−r}→{1, 2, . . . , 2^{k}} denotes a partitioning of the bit positions. Then, the sequence of contexts is given by f(B(l+1)), f((B(l+2)), . . . , f((B(n−r)).

There are 2^{k}! possible one-to-one mappings of the 2^{k} bins to different k-bit strings. In the preferred embodiments, the sole, or at least primary, consideration in selecting from among the possible mappings is: which of the possible mappings results in a context sequence that is closest to a valid context sequence? That is, in the present example a selected mapping converts a sequence of bit positions into a sequence of contexts. However, in many cases an identified sequence of contexts is not valid, i.e., cannot exist within a source file.

In the present discussion, cₗ₊₁cₗ₊₂ . . . cₙ₋ᵣ denotes a sequence of contexts, where each of the cᵢ's is a k-bit string. Such a sequence of contexts is valid, or in other words, represents the sequence of contexts of consecutive bits only if for all i the last k−1 bits of cᵢ equal the first k−1 bits of cᵢ₊₁. The set of valid sequences of contexts can be represented by the set of all valid paths on the graph Gₖ=(Vₖ, Eₖ) described below. The vertex set Vₖ is the set of all k-bit strings. There is a directed edge from vertex a to vertex b if and only if the last k−1 bits of the context represented by vertex a equals the first k−1 bits of the context represented by b. Such a graph is called a De Bruijn graph (see e.g., Van Lint and Wilson, “A course in combinatorics”, Cambridge University Press). Each valid sequence of contexts corresponds to a valid path on the graph. In this discussion, it is assumed that Lₖ denotes the set of all valid sequences of k-bit contexts in a length n string.

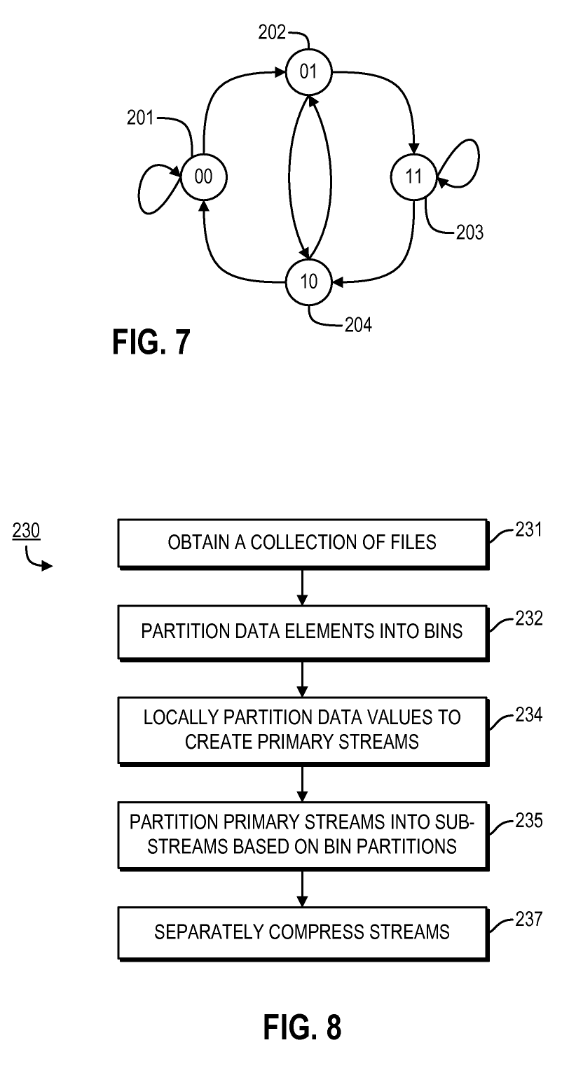

FIG. 7 illustrates the De Bruijn graph G₂. As shown, the sequence of contexts 00, 01, 10, 01, 11, corresponding to the vertices 201, 202, 204, 202 and 203, respectively, is a valid sequence of contexts and 00, 01, 10, 11, corresponding to the vertices 201, 202, 204, 203, respectively, is not, because a transition from vertex 204 to vertex 203 is not permitted.

With this background, it is possible to observe that because neither the partitioning nor the mapping is guaranteed to be correct, the initial sequence of contexts identified by any selected mapping often will not be valid. In order to address this problem, once a mapping has been selected, modifications preferably are made to the sequence of contexts so that a valid sequence of contexts results. Accordingly, one way to select the best mapping is to combine these two steps by performing an exhaustive search over all possible 2^{k}! mappings and over all possible modifications of such mappings in order to find the combination that results in the fewest or, more generally, least-cost modifications. Unfortunately, the computational complexity of this approach is 2^{k}!2^{k} n, which is practical only for very small values of k.

The preferred embodiments therefore separate the determination into two separate steps. In the current step 172, a single mapping (or in certain embodiments, a small set of potential mappings) is identified, preferably by identifying a small set of mappings from among the potential mappings based on degree of matching to a valid sequence of contexts. More preferably, such identification is performed as follows.

For each pair of bins, u,v ε{1, 2, . . . 2^{k}} the weight w(u,v)=|i: B(i)=u, B(i+1)=v|,

which is the number of times i was in bin u and i+1 was in bin v, is computed. Then, for each mapping f, the set of mismatches is defined to be M(f)={(u,v)ε{1, 2, . . . 2^{k}}×{1, 2, . . . 2^{k}}: (f(u),f(v))∉Eₖ},
i.e., the set of all pairs (u,v) such that their mappings (f(u), f(v)) are not in the edge set Eₖ of the De Bruijn graph Gₖ. Then, the mis-match loss of f is defined to be

$$L ( f ) = {\sum }_{( u , v ) ∈ ℳ ( f )} w ( u , v ) ,$$

i.e., a count of the total number of mismatches. The mapping f therefore is selected to be

$$f = \text{arg} {min}_{g : \{ 1 , 2 , … {2}^{k} \} -> {\{ 0 , 1 \}}^{k}} L ( g ) ,$$

i.e., the mapping with the smallest mis-match loss, which again, in the present technique, is simply an unweighted count of the number of mismatches. However, in alternate embodiments, the mis-match loss may be defined as any other function of the mis-matches.

The foregoing minimization can be performed through an exhaustive search. The time complexity of this operation is O(2^{k}!), which can be slightly reduced by taking advantage of certain symmetry arguments. Note that the time complexity does not depend on n (the number of data elements) or on m (the number of files that are being compressed). Therefore, if k is of the order of loglog n, then this computation is negligible compared to the rest of the compression technique.

In certain embodiments, only the mapping having the absolute minimum mis-match loss is selected in this step 172. However, it is noted that this mapping is not guaranteed to result in the best valid sequence of contexts. Accordingly, in other embodiments a small set of the mappings having the lowest mis-match losses is selected in this step 172 (e.g., a fixed number of mappings or, if a natural cluster of mappings with the lowest mis-match losses appears, all of the mappings in such cluster).

In step 174, the next (or first, if this is the first iteration within the overall execution of method 170) mapping that was selected in step 172 is evaluated. Preferably, this step is performed by identifying the “closest” valid sequence of contexts for such mapping and calculating a measure of the distance between that “closest” sequence and the initial context sequence, i.e., the one that is directly generated by the mapping.

In the preferred embodiments, the “closest” valid sequence of contexts for a particular mapping is determined to be

$${\overline{c}}^{*} = \text{arg} {min}_{\overline{c} = {c}_{𝓁 + 1} , {c}_{2} , … , {c}_{n - r} ∈ {ℒ}_{k}} {\sum }_{i = 𝓁 + 1}^{n - r} 1 ( f ( B ( i ) ) \neq {c}_{i} )$$

where 1(·) is the indicator function, i.e., is equal to 1 if its argument is true and 0 otherwise. In other words, the identified closest valid sequence of contexts is the one that differs the least from f(B(l+1)), f((B(l+2)), . . . , f((B(n−r)). The search for the minimum can be accomplished by a standard dynamic programming algorithm that is similar to the Viterbi algorithm (e.g., G. D. Forney, “The Viterbi Algorithm” Proceedings of the IEEE 61(3):268-278, March 1973). The time complexity of such an algorithm is O(2^{k} n). It is noted that the present embodiment uses a particular cost function in which each difference in the context sequences is assigned an equal weight. In alternate embodiments, any other cost function instead could be used, e.g., counting the minimum number of bits that would need to be changed to result in a valid sequence.

In step 175, a determination is made as to whether all the mappings identified in step 172 have been evaluated. If not, processing returns to step 174 to evaluate the next one. If so, processing proceeds to step 177.

In step 177, the best mapping is identified. Preferably, if more than one mapping was identified in step 172, then the one resulting in the lowest cost to convert its initial context sequence into a valid context sequence (e.g., using the same cost function used in step 174) is selected.

Finally, in step 179 the valid sequence of contexts selected in step 174 for the mapping identified in step 177 is used to generate the source file estimate 135. This step can be accomplished in a straightforward manner, e.g., with the first context defining the first k bits of the source file estimate 135 and the last bit of each subsequent context defining the next bit of the source file estimate 135.

The foregoing approach explicitly determines a source file estimate 135 and then uses that source file estimate 135 as a reference for compressing a number of other files. Other processes in accordance with certain concepts of the present invention provide for compression without the need to explicitly determine a source file estimate.

One such process 230 is illustrated in FIG. 8. Each of the steps of method 230 preferably is performed in a predetermined manner, so that the entire process 230 can be performed by a computer processor executing machine-readable process steps, or in any of the other ways described herein.

Initially, in step 231 a collection of files is obtained. This step is similar to step 101, described above in connection with FIG. 4, and the same considerations apply here. As in that technique, the obtained files preferably contain a common set of data elements.

In step 232, those data elements are partitioned into different bins. This step is similar to step 171, described above in connection with FIG. 6, and the same set of considerations generally apply here. However, in step 171 the data elements preferably are partitioned into 2^{k} bins whereas in this step 232 there is no preference that the number of resulting bins be a power of 2.

In step 234, the data values in one or more files are partitioned based on (preferably, exclusively based on) the local data values themselves. In one example, a particular file is partitioned into several streams based on the context of the bits, e.g., the previous k bits in the file. More specifically, with respect to this example, assume that k=3. Then, all the bits in the file that are preceded by 000 form a stream, all the bits preceded by 001 form another stream, and so on.

In alternate embodiments, other local criteria are used (either instead or in addition), such as the particular data values that are themselves being assigned to the different streams, particularly where the data elements can have a wider range of values. In such a case, for example, data values falling within certain ranges are steered toward certain streams.

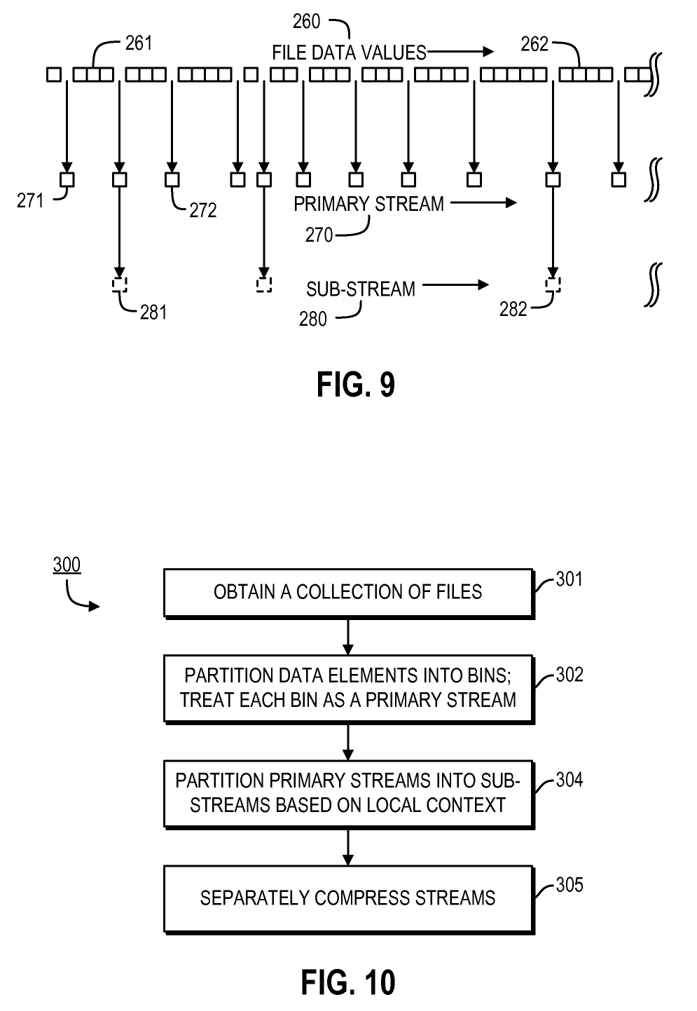

In any event, the result is illustrated in FIG. 9. Here, the sequence of data values 260 for the entire file (e.g., including data values 261 and 262) have been evaluated and separated into streams, referred to as “primary streams” in the present embodiment. For example, primary stream 270 has been generated by taking certain data values (e.g., data values 271 and 272) from the original sequence of data values 260 according to the specified criterion for this primary stream 270 (e.g., any of the criteria described above). Again, each value in the original sequence 260 preferably is steered to one of the pre-defined streams based on the partitioning criterion.

In step 235, each of the primary streams is further partitioned into sub-streams based on the bin partitions identified in step 232. For example, all the data values within a primary stream whose corresponding data elements belong to the same bin are grouped together within a sub-stream. Thus, referring again to FIG. 9, certain values are extracted from the stream 262 (e.g., based solely on the data elements to which they pertain) in order to create a sub-stream 264. More specifically, keeping with the same example described above, data values 281 and 282 are extracted from primary stream 270 to create sub-stream 280 simply because they correspond to the 6^{th} and 39^{th} bit positions in the original data file 266 and because such bit positions had been assigned to these same bin in step 232.

Finally, in step 237 the individual streams are separately compressed. Preferably, the compressed streams are the sub-streams that were generated in step 235. However, in certain embodiments the primary streams generated in step 234 are compressed without any sub-partitioning (in which case, steps 232 and 235 can be omitted). In any event, each of the relevant streams can be compressed using any available (preferably lossless) compression technique(s), such as Lempel-Ziv algorithms (LZ '77, LZ'78) or Krichevsky-Trofimov probability assignment followed by arithmetic coding (e.g. R. Krichevsky and V. Trofimov, “The performance of universal encoding”, IEEE Transactions on Information Theory, 1981).

The streams generated for individual files (such as each of the files obtained in step 231) can be compressed in the foregoing manner. Alternatively, multiple files can be compressed together, e.g., by concatenating their corresponding streams and then separately compressing such composite streams.

A somewhat different method 300 for compressing files without the intermediate step of constructing a source file estimate is now discussed with reference to FIG. 10. Each of the illustrated steps preferably is performed in a predetermined manner, so that the entire process 300 can be performed by a computer processor executing machine-readable process steps, or in any of the other ways described herein.

Initially, in step 301 a collection of files is obtained. This step is similar to step 101, described above in connection with FIG. 4, and the same considerations apply here. As in that technique, the obtained files preferably contain a common set of data elements.

In step 302, those data elements are partitioned into different bins. This step is similar to step 232, described above in connection with FIG. 8, and the same set of considerations generally apply here. However, in the present embodiment the values of the data elements within individual bins are treated as the separate primary data streams (e.g., primary stream 270 shown in FIG. 9).

In step 304, those primary streams preferably are partitioned into sub-streams based on local context (e.g., the context of each of the respective data values). More preferably, with respect to a given file X̅ᵢ, the data values within each bin B₁, 1≦j≦l, are partitioned into 2^{p} sub-streams such that all the data values in a sub-stream have the same context in X̅ᵢ, e.g., the preceding p bits of all the data values in a given sub-stream are identical.

Finally, in step 305 the individual streams are separately compressed. Preferably, the compressed streams are the sub-streams that were generated in step 304. However, in certain embodiments the primary streams generated in step 302 are compressed without any sub-partitioning (in which case, step 304 can be omitted). In any event, each of the relevant streams can be compressed using any available (preferably lossless) compression technique(s), such as Krichevsky-Trofimov probability assignment followed by arithmetic coding.

The streams generated for individual files (such as each of the files obtained in step 301) can be compressed in this manner. Alternatively, multiple files can be compressed together, e.g., by concatenating their corresponding streams and then separately compressing such composite streams.

It is noted that the foregoing discussion primarily focuses on compression techniques. Decompression ordinarily will be performed in a straightforward manner based on the kind of compression that is actually applied. That is, the present invention generally focuses on certain pre-processing that enables a collection of similar files to be compressed using available (e.g., conventional) compression algorithms. Accordingly, the decompression step typically will be a straightforward reversal of the selected compression algorithm.

It is further noted that the present techniques are amenable to two different settings—batch and sequential. In the batch compression setting, the compressor has access to all the files at the same time. The technique generates the appropriate statistical information across such files (e.g., just bin partitions or a source file estimate that has been constructed using those partitions), and then each file is compressed based on this information. In this setting, to decompress a particular file, only the applicable statistical information (e.g., just bin partitions or the source file estimate) and the concerned file are required.

In the sequential compression setting, files arrive sequentially to the compressor which is required to compress the files on-line. Therefore, the statistical information changes with the examination of each new file. The i^{th} file is compressed with respect to \hat{f}ᵢ, the source file estimate after the observation of i files. Alternatively, as noted above, if it is assumed that a new file has been generated in a similar manner to the previous files, or otherwise is statistically similar to such previous files, it can be compressed without modifying such statistical information.

In certain of the embodiments discussed above, data (typically across multiple files) are divided into bins, sub-bins, streams and/or sub-streams which are then processed distinctly in some respect (e.g., by separately compressing each, even if the same compression methodology is used for each). Unless clearly and expressly stated to the contrary, such terminology is not intended to imply any requirement for separate storage of such different bins, sub-bins, streams and/or sub-streams. Similarly, the different bins, sub-bins, streams and/or sub-streams can even be processed together by taking into account the individual bins, sub-bins, streams and/or sub-streams to which the individual data values belong.

It is further noted that the source file estimate 135, or the information for partitioning into bins, sub-bins, streams and/or sub-streams, in the case where a source file estimate is not explicitly constructed, preferably is compressed (e.g., using conventional techniques) and stored for later use in decompressing files, when desired. However, either type of information instead can be stored in an uncompressed form.

### System Environment.

Generally speaking, except where clearly indicated otherwise, all of the systems, methods and techniques described herein can be practiced with the use of one or more programmable general-purpose computing devices. Such devices typically will include, for example, at least some of the following components interconnected with each other, e.g., via a common bus: one or more central processing units (CPUs); read-only memory (ROM); random access memory (RAM); input/output software and circuitry for interfacing with other devices (e.g., using a hardwired connection, such as a serial port, a parallel port, a USB connection or a firewire connection, or using a wireless protocol, such as Bluetooth or a 802.11 protocol); software and circuitry for connecting to one or more networks, e.g., using a hardwired connection such as an Ethernet card or a wireless protocol, such as code division multiple access (CDMA), global system for mobile communications (GSM), Bluetooth, a 802.11 protocol, or any other cellular-based or non-cellular-based system), which networks, in turn, in many embodiments of the invention, connect to the Internet or to any other networks; a display (such as a cathode ray tube display, a liquid crystal display, an organic light-emitting display, a polymeric light-emitting display or any other thin-film display); other output devices (such as one or more speakers, a headphone set and a printer); one or more input devices (such as a mouse, touchpad, tablet, touch-sensitive display or other pointing device, a keyboard, a keypad, a microphone and a scanner); a mass storage unit (such as a hard disk drive); a real-time clock; a removable storage read/write device (such as for reading from and writing to RAM, a magnetic disk, a magnetic tape, an opto-magnetic disk, an optical disk, or the like); and a modem (e.g., for sending faxes or for connecting to the Internet or to any other computer network via a dial-up connection). In operation, the process steps to implement the above methods and functionality, to the extent performed by such a general-purpose computer, typically initially are stored in mass storage (e.g., the hard disk), are downloaded into RAM and then are executed by the CPU out of RAM. However, in some cases the process steps initially are stored in RAM or ROM.

Suitable devices for use in implementing the present invention may be obtained from various vendors. In the various embodiments, different types of devices are used depending upon the size and complexity of the tasks. Suitable devices include mainframe computers, multiprocessor computers, workstations, personal computers, and even smaller computers such as PDAs, wireless telephones or any other appliance or device, whether stand-alone, hard-wired into a network or wirelessly connected to a network.

In addition, although general-purpose programmable devices have been described above, in alternate embodiments one or more special-purpose processors or computers instead (or in addition) are used. In general, it should be noted that, except as expressly noted otherwise, any of the functionality described above can be implemented in software, hardware, firmware or any combination of these, with the particular implementation being selected based on known engineering tradeoffs. More specifically, where the functionality described above is implemented in a fixed, predetermined or logical manner, it can be accomplished through programming (e.g., software or firmware), an appropriate arrangement of logic components (hardware) or any combination of the two, as will be readily appreciated by those skilled in the art.

It should be understood that the present invention also relates to machine-readable media on which are stored program instructions for performing the methods and functionality of this invention. Such media include, by way of example, magnetic disks, magnetic tape, optically readable media such as CD ROMs and DVD ROMs, or semiconductor memory such as PCMCIA cards, various types of memory cards, USB memory devices, etc. In each case, the medium may take the form of a portable item such as a miniature disk drive or a small disk, diskette, cassette, cartridge, card, stick etc., or it may take the form of a relatively larger or immobile item such as a hard disk drive, ROM or RAM provided in a computer or other device.

The foregoing description primarily emphasizes electronic computers and devices. However, it should be understood that any other computing or other type of device instead may be used, such as a device utilizing any combination of electronic, optical, biological and chemical processing.

### Additional Considerations.

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Similarly, in the discussion above, functionality sometimes is ascribed to a particular module or component. However, functionality generally may be redistributed as desired among any different modules or components, in some cases completely obviating the need for a particular component or module and/or requiring the addition of new components or modules. The precise distribution of functionality preferably is made according to known engineering tradeoffs, with reference to the specific embodiment of the invention, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention be considered as within the scope thereof as limited solely by the claims appended hereto.

What is claimed is:

1. A method of collaborative compression, comprising:
obtaining a collection of files, with individual ones of the files including a set of ordered data elements, and with individual ones of the data elements having different values in different ones of the files, but with the set of ordered data elements being common across the files;
partitioning the data elements into an identified set of bins based on statistics for the values of the data elements across the collection of files; and
compressing a received file based on the bins of data elements.

2. A method according to claim 1, wherein said compressing step comprises constructing a source file estimate and compressing the received file relative to the source file estimate.

3. A method according to claim 2, further comprising a step of compressing substantially all of the files within the collection relative to the source file estimate.

4. A method according to claim 2, wherein the source file estimate is constructed by mapping the identified set of bins to an initial set of contexts in the source file estimate and then generating a valid sequence of contexts based on the mapping.

5. A method according to claim 4, wherein the mapping is identified by evaluating a plurality of potential mappings based on degree of matching to a valid sequence of contexts.

6. A method according to claim 2, wherein the source file estimate is constructed primarily based on a criterion of identifying a valid sequence of contexts within the source file estimate that corresponds to the identified set of bins.

7. A method according to claim 1, wherein said compressing step comprises generating streams of data values based on the bins and then separately compressing the streams.

8. A method according to claim 7, wherein the streams are generated by performing local partitioning of the data values in an individual file and then performing further partitioning based on the bins.

9. A method according to claim 7, wherein the streams are generated by partitioning data values in the bins based on local context.

10. A method according to claim 1, wherein individual ones of the data elements are assigned to the bins based on values of nearby ones of the data elements.

11. A method according to claim 1, wherein the data elements are different bit positions in the files, such that a single data element represents a common bit position across the files.

12. A method according to claim 11, wherein a bit position is assigned to one of the bins based on a fraction of the files in which the bit position has a specified value.

13. A method according to claim 1, wherein a data element is assigned to one of the bins based on a representative value for the data element across all of the files in the set.

14. A method of collaborative compression, comprising:
obtaining a collection of files, with individual ones of the files including a set of ordered data elements, and with individual ones of the data elements having different values in different ones of the files, but with the set of ordered data elements being common across the files;
constructing a source file estimate based on statistics for the values of the data elements across the collection of files; and
compressing a received file relative to the source file estimate.

15. A method according to claim 14, wherein the source file estimate is constructed by mapping an identified set of bins to an initial set of contexts in the source file estimate and then generating a valid sequence of contexts based on the mapping.

16. A method according to claim 15, wherein the mapping is identified by evaluating a plurality of potential mappings based on degree of matching to a valid sequence of contexts.

17. A method according to claim 14, wherein the source file estimate is constructed primarily based on a criterion of identifying a valid sequence of contexts within the source file estimate that corresponds to an identified set of bins.

18. A computer-readable medium storing computer-executable process steps for collaborative compression, said process steps comprising:
obtaining a collection of files, with individual ones of the files including a set of ordered data elements, and with individual ones of the data elements having different values in different ones of the files, but with the set of ordered data elements being common across the files;
partitioning the data elements into an identified set of bins based on statistics for the values of the data elements across the collection of files; and
compressing a received file based on the bins of data elements.

19. A computer-readable medium according to claim 18, wherein said compressing step comprises constructing a source file estimate and compressing the received file relative to the source file estimate.

20. A computer-readable medium according to claim 18, wherein said compressing step comprises generating streams of data values based on the bins and then separately compressing the streams.
